(19) United States
(12) Patent Application Publication
(10) Pub. No.: US 2009/0240870 A1
(43) Pub. Date: Sep. 24, 2009

(54) STORAGE APPARATUS WITH A PLURALITY OF NONVOLATILE MEMORY DEVICES

(75) Inventor: Tadaaki KINOSHITA, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, TOKYO (JP)

(21) Appl. No.: 12/361,355

(22) Filed: Jan. 28, 2009

(30) Foreign Application Priority Data
Mar. 21, 2008 (JP) 2008-074293

(51) Int. Cl. G06F 12/02; G06F 12/00

(52) U.S. Cl. 711/103; 711/170; 711/E12.001; 711/E12.008

(57) ABSTRACT

According to one embodiment, a counter counts bits having a predetermined logical value contained in accessed data to be written or read in an access process of accessing any of the physical blocks provided in a selected one of the nonvolatile memory devices. A timer measures an access busy period in the access process. A control module updates an access busy period data item stored in a busy period storage module and concerning the selected one, in accordance with a count value of the counter, whereby the access busy period data item represents the access busy period measured.

### CROSS-REFERENCE TO RELATED APPLICATIONS

This application is based upon and claims the benefit of priority from Japanese Patent Application No. 2008-074293, filed Mar. 21, 2008, the entire contents of which are incorporated herein by reference.

### BACKGROUND

1. Field

One embodiment of the invention relates to a storage apparatus with a plurality of nonvolatile memory devices. More particularly, it relates to a storage apparatus which has a plurality of nonvolatile memory devices and in which the access busy periods of the respective nonvolatile memory devices can be managed well.

2. Description of the Related Art

The storage area of a nonvolatile memory device in which data is rewritable (that is, programmable) is generally divided into blocks (physical blocks) of a specific size, which are managed one by one. Known as a representative example of such a nonvolatile memory device is the NAND nonvolatile memory device.

Jpn. Pat. Appln. KOKAI Publication No. 2005-250619, Jpn. Pat. Appln. KOKAI Publication No. 2006-302255 and Jpn. Pat. Appln. KOKAI Publication No. 2000-112818, for example, disclose nonvolatile memory devices such as NAND nonvolatile memory devices. These nonvolatile memory devices are characterized in that they (or the blocks provided in each device) differ from one another in terms of busy period, even if they are mounted on products of the same kind, respectively, and have been programmed the same number of times. As is known in the art, the access busy period of such a nonvolatile memory device increases as the device undergoes the programming/erase again and again. This means that the access busy period of the nonvolatile memory device (or of each block provided in the device) represents the performance or degradation of the device (or each block).

Jpn. Pat. Appln. KOKAI Publication No. 2005-250619, identified above, discloses the technique of monitoring the access busy period (write time) of each block (physical block) provided in a nonvolatile memory device, thereby to classify the blocks in rank of the lowest guaranteed access speed.

However, the inventor hereof has come to believe that in a nonvolatile memory device, a block determined to have a short access busy period does not always have a higher access speed than a block determined to have a long access busy period. The reasons why the inventors believe so will be stated below.

In the nonvolatile memory device, data is written to a block (physical block), usually in the following way. Assume that the block to which to write data has already been erased. The “block has already been erased” means that all bits of the block are set to the first logical value (for example, “1”). More specifically, any block is “erased” if the voltages of the cells, each constituting one bit of the block, are set to the level that represents the first logical value.

To write data to a block, some of all bits now set to the first logical value (i.e., “1”), therefore remaining in erased state, are set to the second logical value (i.e., “0”) that differs from the first logical value. To describe it in more detail, the voltage of the cells constituting the bits that should be set to the second logical value is changed from the level representing the first logical value to the level representing the second logical value. At this time, write verification is performed, determining whether the bits which should be set to the second logical value (or the cells constituting these bits) have been duly set to the second logical value (i.e., voltage level representing the second logical value.)

Any one of the bits that should be set to the second logical value may not be set to the second logical value (i.e., voltage level representing the second logical value). In this case, this bit (or the cell constituting this bit) is set to the second logical value (i.e., voltage level representing the second logical value), and the write verification is performed again. This operating sequence is repeated until it is confirmed that all bits (i.e., cells constituting these bits) that should be set to the second logical value have been set to the second logical value (i.e., voltage level representing the second logical value). Consequently, the time required to write to a block the data including many bits having the second logical value differs from the time required to write to a block the data including few bits having the second logical value, even if these blocks undergo the programming/erase the same number of times. (That is, these blocks have different access busy periods.)

### BRIEF DESCRIPTION OF THE SEVERAL VIEWS OF THE DRAWINGS

A general architecture that implements various features of the invention will now be described with reference to the drawings. The drawings and their associated descriptions are provided to illustrate the embodiments of the invention and not to limit the scope of the invention.

FIG. 1 is a block diagram showing an exemplary configuration of a storage apparatus according to an embodiment of the invention;

FIG. 2 is a diagram explaining an exemplary storage area defined by the nonvolatile memory devices shown in FIG. 1;

FIG. 3 is a diagram showing an example of an address translation table, which may be stored in the address translation table area shown in FIG. 1;

FIG. 4 is a diagram showing an example of physical block status data stored in the status area shown in FIG. 1;

FIG. 5 is a diagram showing an example of access busy period data stored in the busy period area shown in FIG. 1;

FIG. 6 is a diagram showing an example of access frequency data stored in the access frequency area shown in FIG. 1;

FIGS. 7A and 7B show an exemplary flowchart explaining how a write command is processed in the embodiment;

FIGS. 8A and 8B show an exemplary flowchart explaining how a write command is processed in a first modification of the embodiment;

FIG. 9 is a diagram showing an example of access busy period data used in a second modification of the embodiment; and

FIG. 10 is a block diagram showing an exemplary configuration of nonvolatile memory devices used in a third modification of the embodiment.

### DETAILED DESCRIPTION

Various embodiments according to the invention will be described hereinafter with reference to the accompanying drawings. In general, according to one embodiment of the invention, a storage apparatus accessible from a host is provided. This apparatus comprises: a plurality of nonvolatile memory devices configured to be managed in the form of a plurality of physical blocks, each of the physical blocks being constituted by bits and configured to be erased when the bits are set to a first logical value; a counter configured to count bits having a second logical value contained in accessed data to be written or read in an access process of accessing any physical block provided in a selected one of the nonvolatile memory devices; a timer configured to measure an access busy period in the access process; a busy period storage module configured to store access busy periods for at least the nonvolatile memory devices; and a control module configured to update an access busy period data item stored in the busy period storage module and concerning the selected one, in accordance with a count value of the counter, whereby the access busy period data item represents the access busy period measured.

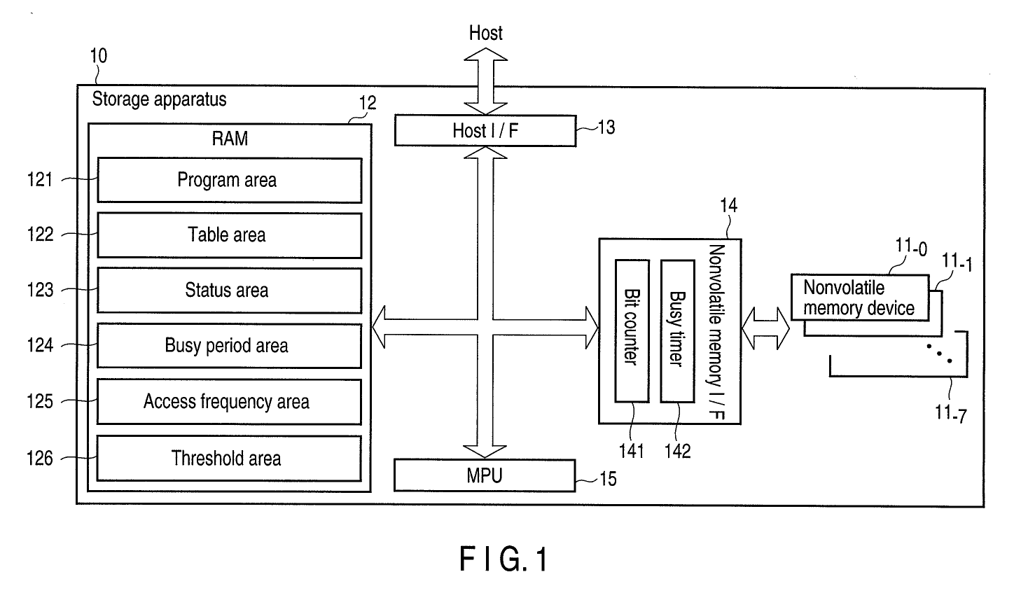

FIG. 1 is a block diagram showing the configuration of a storage apparatus 10 according to an embodiment of the invention. As FIG. 1 shows, the storage apparatus 10 includes a plurality of nonvolatile memory devices, for example eight devices 11-0, 11-1, . . . , 11-7. The storage apparatus 10 further includes a RAM 12, a host interface module (host interface) 13, a nonvolatile memory interface module (nonvolatile memory interface) 14, and a microprocessor unit (MPU) 15.

Each nonvolatile memory device 11-m (m=0, 1, . . . , 7) comprises, for example, a NAND nonvolatile memory (flash memory). The storage area of the nonvolatile memory device 11-m is divided into blocks (physical blocks) of a specific size. The blocks are managed one by one. The nonvolatile memory device 11-m is therefore managed, block by block.

In the embodiment, the nonvolatile memory devices 11-m are binary nonvolatile memories (binary memories). Each bit of any physical block is a smallest unit of data and has one of the first and second logical values. Here, the first logical value is “1,” and the second logical value is “0.” Assume that all bits of any physical block are set to the first logical value “1” while the physical block remains in erased state.

Also assume that an ID (IDm) having value m is assigned to the nonvolatile memory device 11-m. More specifically, seven IDs (nonvolatile memory device IDs), 0(00) to 7(07), are assigned to the nonvolatile memory devices 11-0 to 11-7, respectively.

In the storage area of the RAM 12, various areas are provided, such as a program area 121, a table area 122, a status area 123, a busy period area 124, an access frequency area 125, and a threshold area 126. The storage area of the RAM 12 further includes a buffer area (not shown), which the MPU 15 may utilize.

The program area 121 is used as a program storage module that stores programs the MPU 15 may execute. The table area 122 is used as a table storage module that stores an address translation table. The address translation table shows which physical blocks provided in the storage areas of the nonvolatile memory devices 11-0 to 11-7 are allocated to which logical blocks provided in a logical address space that a host can recognize. The table holds the physical block addresses allocated to the logical blocks designated by the logical block addresses in the logical address space and associated with these logical block addresses.

The status area 123 is used as a status storage module that stores physical block status data items. The physical block status data items represent the statuses of the physical blocks provided in the storage areas of the nonvolatile memory devices 11-0 to 11-7, in association with the addresses of the physical blocks. In this embodiment, the status of the physical block represented by each block status data item is either “in use” or “not in use.”

The busy period area 124 is used as a busy period storage module that stores the data items (access busy period data items) representing the access busy periods of the nonvolatile memory devices 11-0 to 11-7, in association with the IDs of the nonvolatile memory devices 11-0 to 11-7. The access busy period of any one of the nonvolatile memory devices 11-0 to 11-7 is the time elapses before data can be written to the nonvolatile memory device.

The access frequency area 125 is used as an access frequency storage module that stores the data item (address frequency data item) representing the access frequency of each logical block provided held in the logical address space. The threshold area 126 is used as a threshold storage module that stores first and second threshold values. The first threshold value is used to determine whether or not to store the data item (access busy period data item) representing the access busy period measured by a busy timer 142 in the busy period area 124, when data are written to the nonvolatile memory device 11-m. The first threshold value is a reference value representing the number of “0” bits, i.e., bits having the second logical value (reference value) and included in the data to be written to a physical block. The second threshold value represents an access busy period that is used as reference for selecting any nonvolatile memory device in which the data the host has designated should be written.

The host interface (host I/F) 13 is interface between the host and the storage apparatus 10. The host I/F 13 receives any command transferred from the host to the storage apparatus 10 and supplies the command to the MPU 15. The nonvolatile memory interface (nonvolatile memory I/F) 14 is an interface that enables the MPU 15 to make access to any nonvolatile memory device 11-m. The nonvolatile memory I/F 14 includes a bit counter 141 and the busy timer 142 mentioned above.

The bit counter 141 counts the bits having the second logical value (“0”) and contained in the data that should be written to the nonvolatile memory device 11-m, when the data is written to the nonvolatile memory device 11-m. The busy timer 142 measures the busy period (access busy period) that elapses before the data can be written to the nonvolatile memory device 11-m.

The MPU 15 executes any command from the host that uses the storage apparatus 10, in accordance with a program stored in the program area 121 of the RAM 12. The MPU 15 therefore functions as a controller (control module) in the storage apparatus 10. If the command from the host is a read/write command, the MPU 15 will control the access to the nonvolatile memory device 11-m.

The MPU 15 particularly refers to the busy period area 124, status area 123 and access frequency area 125 if the command from the host is a write command. In this case, the MPU 15 selects a physical block which should be allocated to the logical block designated by the write command and to which data should be written.

If the logical block the write command designates has a high access frequency, a physical block will be selected, which has a high access speed (short busy period) and which has not been used (not in use). If the logical block the write command designates has a low access frequency, a physical block will be selected, which has a low access speed (long busy period) and which has not been used (not in use).

The MPU 15 writes the data from the host to the physical block thus selected, through the nonvolatile memory I/F 14. Further, the MPU 15 updates the status of the physical block selected, which is stored in the status area 123.

The MPU 15 performs a block address boundary adjustment (known as “move process”) if the start address designated by the write command from the host is not a block boundary or if the end address is not a boundary. In the block address boundary adjustment, the MPU 15 utilizes the buffer area provided in the RAM 12.

The address designated by the command from the host is a logical address. Therefore, the logical address (i.e., logical block address) must be converted to a physical address (i.e., physical block address.

The MPU 15 therefore enters the logical address from the host in the table area 122 (more precisely, in the address translation table), in association with the physical block address of the physical block selected, when it writes the data sent from the host to the physical block selected. Then, the MPU 15 can obtain the physical block associated with the logical block address designated by the read command, merely by referring to the table area 122 (or the address translation table), in order to make access to the physical block in accordance with the read command from the host. The MPU 15 accesses, via the nonvolatile memory I/F 14, the physical block designated by the physical block address obtained. From the physical block thus designated, the MPU 15 can read the data designated by the read command. The MPU 15 transfers the data thus read, to the host through the host I/F 13.

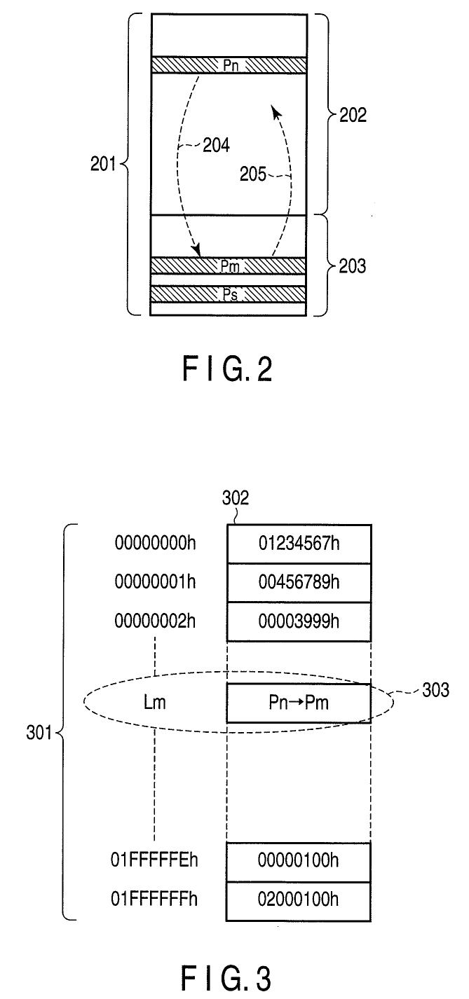

FIG. 2 is a diagram explaining an exemplary storage area 201 defined by the nonvolatile memory devices 11-0 to 11-7 shown in FIG. 1. The storage area 201 is composed of a plurality of physical blocks. To be more specific, the storage area 201 is composed of two physical block sections 202 and 203. The physical block section 202 is a set of physical blocks already allocated to logical blocks, respectively. The physical block section 203 is a set of physical blocks that can be allocated to logical blocks, respectively. In the storage area 201, the physical block sections 202 and 203 are therefore managed independently. The physical block sections 202 and 203 shown in FIG. 2 are logically classified, and have no positional relation in the physical address space provided in the storage area 201.

As long as the storage area 201 assumes the state shown in FIG. 2, physical block Pn belongs to the physical block section 202, while physical blocks Pm and Ps belong to the physical block section 203. Arrows 204 and 205, both shown in FIG. 2, will be explained later.

FIG. 3 is a diagram showing an example of the address translation table, which may be stored in the table area 122 shown in FIG. 1. In FIG. 3, address translation table includes logical block addresses 301 are equivalent to the indexes of the address translation table. Physical block address data field 302 is used to hold (or enter) the physical block addresses (physical block address data items) allocated to the logical block addresses, respectively. In the address translation table of FIG. 3, the physical block address “00003999h” is held in the physical block address data field 302 associated with, for example, the logical block address “00000002h.” (Here, the last character “h” indicates that “00000002” is a hexadecimal notation.) This means that the physical block having the physical block address “00003999h” is allocated to the logical block having the logical block address “00000002h”. That part of FIG. 3, which lies in the ellipse 303, will be explained later.

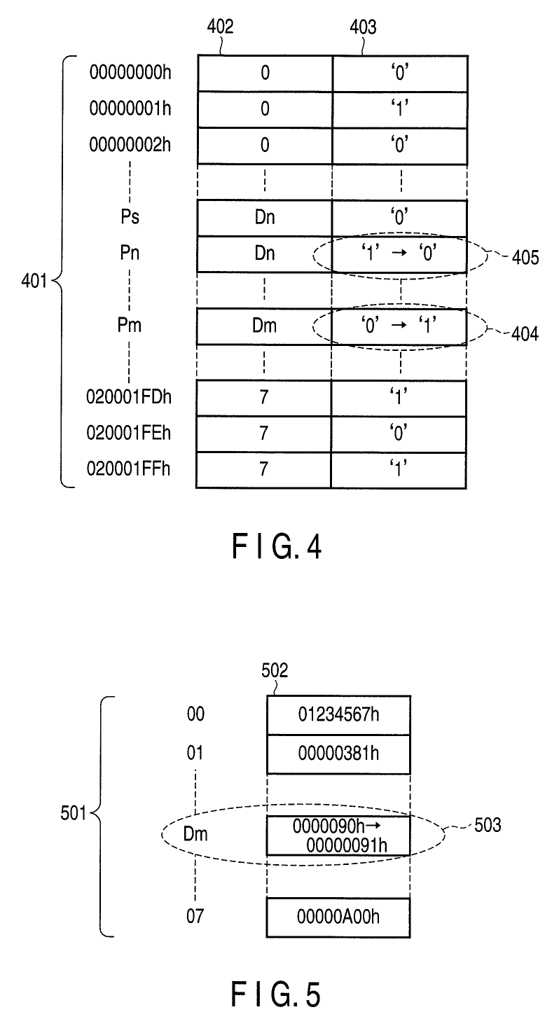

FIG. 4 is a diagram showing an example of physical block status data stored in the status area 123 shown in FIG. 1. As FIG. 4 shows, the physical block status data is managed in the form of a table. Physical block addresses 401 shown in FIG. 4 are equivalent to the indexes of the table. The physical block status data is composed of physical block status data items. The physical block status data items are equivalent to the data parts of the table that are identified with respective indexes. Thus, each physical block status data item is associated to a physical block address. Each physical block status data item is composed of an ID field 402 and a status field 403.

The ID field 402 is used to hold the ID (nonvolatile memory device ID) of a nonvolatile memory device 11-m that has the physical block designated by the associated physical block address. The status field 403 is used to hold the status of a physical block designated by the associated physical block address. The physical block address is the index of the data part (i.e., physical block status data item) that contains the associated ID field 402 and associated status field 403.

The status is data indicating whether the associated physical block is in use or not. Any “physical block in use” belongs to the physical block section 202 shown in FIG. 2. On the other hand, any “physical block not in use” belongs to the physical block section 203 shown in FIG. 2. Those parts of FIG. 4, which lie in the ellipses 404 and 405, will be explained later.

FIG. 5 is a diagram showing an example of access busy period data stored in the busy period area 124 shown in FIG. 1. As FIG. 5 shows, the access busy period data is managed in the form of a table. Nonvolatile memory device IDs 501 shown in FIG. 5 are equivalent to the indexes of the table. The access busy period data is composed of the access busy period data items 502. The access busy period data items 502 are equivalent to the data parts of the table that are identified with respective indexes. Thus, the access busy period data items 502 are associated to nonvolatile memory device IDs 501(indexes), respectively. Each access busy period data item 502 represents an access busy period that is required for writing data to a physical block of the nonvolatile memory device identified with the associated nonvolatile memory device ID (index). That part of FIG. 5, which lies in the ellipse 503, will be explained later.

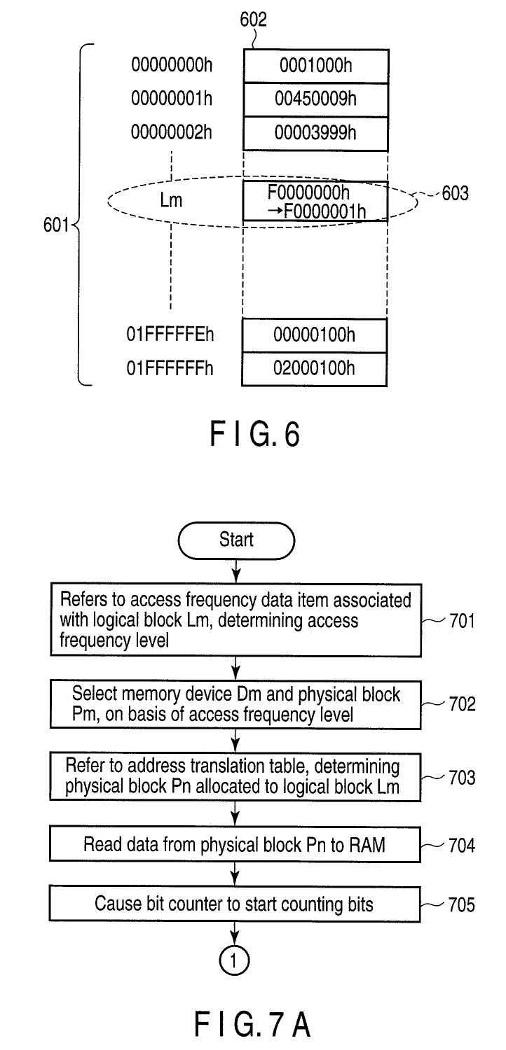

FIG. 6 is a diagram showing an example of access frequency data stored in the access frequency area 125 shown in FIG. 1. As FIG. 6 shows, the access frequency data is managed in the form of a table. Logical block addresses 601 shown in FIG. 6 are equivalent to the indexes of the table. The access frequency data is composed of access frequency data items 602. The access frequency data items 602 are equivalent to the data parts of the table, each of which is identified with an index. That is, the access frequency data items 602 are associated with logical block addresses, respectively. Each access frequency data item 602 represents the frequency of accessing a logical block designated by the associated logical block address.

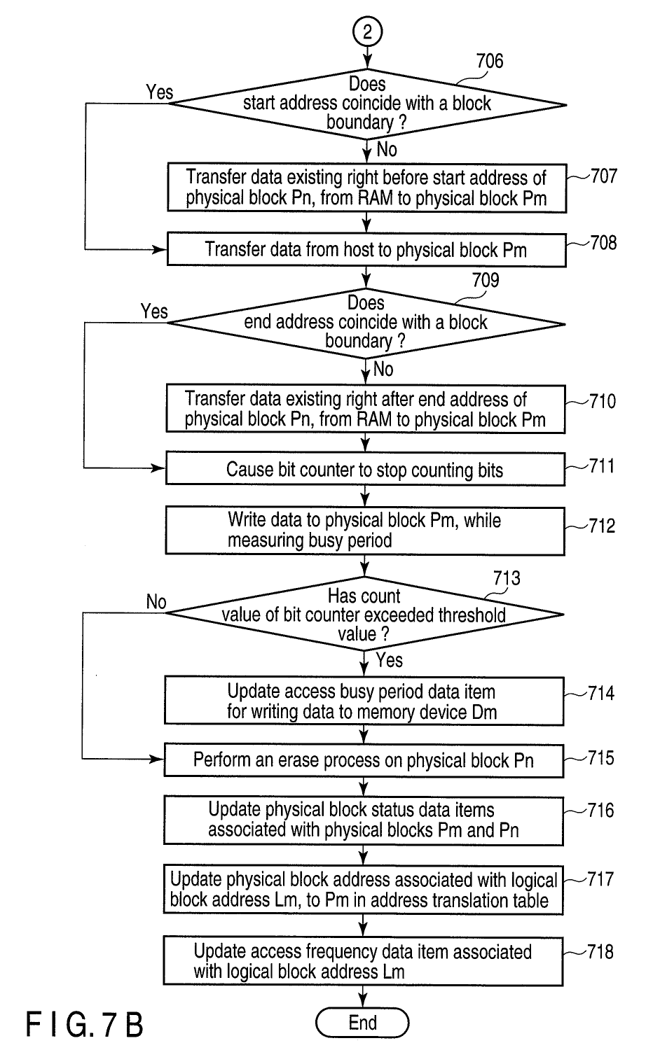

How the storage apparatus 10 shown in FIG. 1 operates in response to process a write command will be explained, with reference to the flowchart of FIGS. 7A and 7B. Assume that the host issues a write command, instructing the storage apparatus 10 to write data. In the storage apparatus 10, the host I/F 13 receives the write command, which is supplied to the MPU 15.

The write command contains a start address (start logical address) and size data. The start address represents that position in the logical address space, at which data writing is started. The size data represents the size of the data to write. From the start address and size data, there will be calculated an end address (end logical address) that indicates the position where the data writing should be terminated. The write command can therefore be regarded as designating not only the start address, but also the end address. The specific upper parts of the start address (start logical address) and end address (end logical address) define a logical block address. The remaining parts (lower parts) of the start address and end address define an intra-block start address and an inter-block end address, respectively. For simplicity of explanation, the start address and the end address are assumed to pertain to the same logical block. Hence, the area designated by the write command, which should therefore be accessed, does not extend over a plurality of logical blocks.

Also assume that in the present embodiment, the start address contained in the write command from the host represents logical block address Lm. That is, the write command from the host instructs that data be written to the logical block (hereinafter referred to as logical block Lm) designated by the logical block address Lm.

On receiving the write command from the host through the host I/F 13, the MPU 15 refers to the access frequency data item 602 (i.e., data item 602 pertaining to the logical block Lm) associated with the logical block Lm which is designated by the write command and which is stored in the access frequency area 125 (Block 701). In Block 701, the MPU 15 determines the level of the frequency of accessing the logical block Lm, from the access frequency represented by the access frequency data item 602 referred to, i.e., the frequency of accessing the logical block Lm. Assume that the access frequency level is either the first level that is higher than a reference access frequency or the second level that is lower than the reference access frequency.

Next, the MPU 15 selects a nonvolatile memory device Dm that has a desirable busy period (i.e., nonvolatile memory device 11-m whose memory device ID is Dm), on the basis of the access busy period data item 502 (see FIG. 5) stored in the busy period area 124 and the access frequency level determined in Block 701 (Block 702).

The access frequency level determined may be the first level. That is, the access frequency of the logical block Lm may be high. In this case, the nonvolatile memory device Dm is selected, because the nonvolatile memory device Dm has an access busy period shorter than the period represented by the threshold value stored in the threshold area 126 (i.e., second threshold value). More specifically, the MPU 15 selects the nonvolatile memory device Dm identified with the nonvolatile memory device ID associated with the access busy period data item 502 that represents an access busy period shorter than the period represented by the second threshold value. The nonvolatile memory device Dm, which has a short access busy period, can be said to be a nonvolatile memory that excels in access speed. If such a nonvolatile memory is used to write data to the logical block Lm that has high access frequency, the write process can be achieved at high speed. This increases the operating speed of the entire storage apparatus 10.

The access frequency level determined may be the second level. That is, the access frequency of the logical block Lm may be low. If this is the case, the nonvolatile memory device Dm is selected, because the nonvolatile memory device Dm has an access busy period longer than the period represented by the second threshold value (i.e., second threshold value). More precisely, the MPU 15 selects the nonvolatile memory device Dm identified with the nonvolatile memory device ID associated with the access busy period data item 502 that represents an access busy period longer than the period represented by the second threshold value. The nonvolatile memory device Dm, which has a long access busy period, can be said to be a nonvolatile memory degraded in access speed. If such a nonvolatile memory is used to write data to the logical block Lm that has low access frequency, the write process will be less influenced than otherwise and the decrease in the speed with which to access the nonvolatile memory can be delayed. This increases the reliability (durability) of the entire storage apparatus 10.

In Block 702, the MPU 15 selects a physical block not used and to be allocated to the logical block Lm, from the physical blocks of the nonvolatile memory device Dm selected, on the basis of the physical block status data stored in the status area 123 (see FIG. 4). Assume that the physical block selected is physical block Pm (i.e., physical block having physical block address Pm). Then, the physical block address of physical block Pm is associated with a physical block status data item representing status “0 (not used)” and indicating that the nonvolatile memory device ID is Dm.

Next, the MPU 15 refers to the address translation table (see FIG. 3) stored in the table area 122, determining the physical block Pn (more precisely, the physical block address thereof) allocated to the logical block Lm at present (Block 703). The MPU 15 reads data from the physical block Pn through the nonvolatile memory I/F 14. The data thus read is stored in the buffer area of the provided in the RAM 12 (Block 704).

The MPU 15 then activates the bit counter 141 incorporated in the nonvolatile memory I/F 14, causing the bit counter 141 to start counting data bits (Block 705). Thus, the bit counter 141 keeps counting the bits having the second logical value (“0”) and contained in the data to supply via the nonvolatile memory I/F 14 to the nonvolatile memory. The bit counter 141 keeps counting the bits until it receives a signal indicating that all bits having the second logical value have been counted.

Then, the MPU 15 determines whether the intra-block start address represented by the start address (i.e., start logical address) contained in the write command from the host coincides with a block boundary (Block 706). If the decision made in Block 706 is No, the MPU 15 selects the data beginning at the start end of the physical block Pn and ending at a position immediately before the intra-block start address, from all data of the physical block Pn stored (read) in the buffer area of the RAM 12, and transfers the data, thus selected, to the physical block Pm provided in the nonvolatile memory device Dm (11-m) selected in Block 702, as a part of the data to be written to the physical block Pm (Block 707). At this point, the bit counter 141 counts the bits contained in the data thus transferred and having the second logical value.

After performing Block 707, the MPU 15 transfers the data designated by the write command from the host (i.e., data supplied from the host) via the nonvolatile memory I/F 14 to the physical block Pm provided in the nonvolatile memory device Dm selected (Block 708). At this point, the bit counter 141 counts the bits contained in the data thus transferred and having the second logical value (“0”). If the decision made in Block 708 is Yes, the process will jump from Block 706 to Block 708, skipping Block 707.

Next, the MPU 15 determines whether the intra-block end address represented by the end address (i.e., end logical address) designated by the write command from the host coincides with a block boundary (Block 709). If the decision made in Block 709 is No, the MPU 15 selects the data beginning at a position immediately after the intra-block end address and ending at the end of the block Pn, from all data of the physical block Pn stored in the buffer area of the RAM 12. The MPU 15 transfers the data, thus selected, to the physical block Pm provided in the nonvolatile memory device Dm (11-m) selected in Block 702, as a part of the data to be written to the physical block Pm (Block 710). At this point, the bit counter 141 counts the bits contained in the data thus transferred and having the second logical value (“0”).

On performing Block 710, the MPU 15 causes the bit counter 141 to stop counting bits (Block 711). If the decision made in Block 709 is Yes, the process will jump from Block 709 to Block 711, skipping Block 710.

Thus, in the present embodiment, the bit counter 141 counts the bits contained in the data to write to the selected physical block Pm and having the second logical value (“0”). The data to write to the selected physical block Pm contains data supplied from the host.

Then, via the nonvolatile memory I/F 14, the MPU 15 instructs the nonvolatile memory device Dm (11-m) to write one-block data transferred to the physical block Pm, to the physical block Pm that is provided in the nonvolatile memory device Dm (11-m) (Block 712). In Block 712, the MPU 15 activates the busy timer 142, which starts measuring an access busy period. The busy timer 142 measures, as access busy period, the period starting when the timer 142 is activated and ending when the data is completely written to the physical block Pm and the nonvolatile memory device Dm (11-m) comes out of a busy state.

When the nonvolatile memory device Dm (11-m) comes out of the busy state, the MPU 15 refers to the count value of the bit counter 141, determining whether the count value has exceeded the threshold value (first threshold value) stored in the threshold area 126 (Block 713). If the decision made in Block 713 is Yes, the MPU 15 determines that the access busy period the busy timer 142 has measured is valid. Why the MPU 15 determines so is as follows.

Data is written to the physical block Pm by setting the voltage applied on those of all cells of the block Pm, which define the bits that should be set to the second logical value (“0”), from the level equivalent to the first logical value (“1”) to the level equivalent to the second logical value (“0”), as has been described in “Description of the Related Art.” At this point, write verification is performed, checking to see whether each cell defining a bit that should be set to the second logical value (“0”) has been set to the voltage level equivalent to the second logical value (“0”). If any cell has not been set to the voltage level equivalent to the second logical value, it is set gain to the voltage level equivalent to the second logical value and the write verification is performed again on this cell.

If the data to write to the physical block Pm includes a few bits that should be set to the second logical value (“0”), the access busy period can be short, not so much influenced by the access speed of the block Pm, even if the access speed is relatively low. In contrast, if the data to write to the physical block Pm includes many bits that should be set to the second logical value (“0”), the access busy period will be greatly influenced if the access speed of the block Pm is low. In other words, the access busy period measured can be said to reflect the access speed of the block Pm sufficiently if the data to write to the physical block Pm include many bits that should be set to the second logical value (“0”). This is why the access busy period measured by the busy timer 142 is used as valid in this embodiment if the count value of the bit counter 141 exceeds the threshold value (first threshold value) (that is, if the decision made in Block 713 is Yes.)

That is, if the decision made in Block 713 is Yes, the MPU 15 updates the access busy period data item 502 stored in the busy period area 124 and associated with the nonvolatile memory device Dm, changing the same to the value representing the access busy period the busy timer 142 has measured (Block 714). That part of FIG. 5, which lies in ellipse 503, is how the busy period data item 502 is updated. In the case shown in FIG. 5, the access busy period data item 502 associated with the device Dm is updated from “0000090h” to “0000091h.”

After performing Block 714, the MPU 15 performs a process (erase process) on the physical block Pn via the nonvolatile memory I/F 14, thus setting the block Pn to a not-used state (Block 715). If the decision made in Block 713 is No, the MPU 15 determines that the access busy period the busy timer 142 measures this time is not valid. In this case, the process will jump from Block 713 to Block 715, skipping Block 714.

On performing Block 715, the MPU 15 updates the physical block status data items stored in the status area 123 and associated with the physical blocks (physical block addresses) Pm and Pn (Block 716). (That is, the MPU 15 updates the statuses indicating the use statuses of the physical blocks Pm and Pn.) Those parts of FIG. 4, which lie in the ellipses 404 and 405, show how the MPU 15 updates these physical block status data items.

In the case shown in FIG. 4, the physical block status data item associated with the physical block (physical block address) Pm is changed from “0” indicating that the block Pm is not in use, to “1” indicating that the block is in use. The physical block status data item associated with the physical block (physical block address) Pn is changed from “1” indicating that the block Pn is in use, to “0” indicating that the block is not in use. Therefore, the physical block Pn no longer belongs to the physical block section 202 and now belongs to the physical block section 203, as indicated by arrow 204 in FIG. 2. On the other hand, the physical block Pm no longer belongs to the physical block section 203 and now belongs to the physical block section 202, as indicated by arrow 205 in FIG. 2.

The MPU 15 updates the physical block address associated with the logical block address Lm, too, from Pn to Pm in the address translation table stored in the table area 122. That part of FIG. 3, which lies in the ellipse 303, shows how the MPU 15 updates the physical block address associated with the logical block address Lm (Block 717).

The MPU 15 updates the access frequency data item 602 stored in the access frequency area 125 and associated with the logical block address Lm (Block 718). More precisely, the MPU 15 increments, by one, the access frequency represented by the access frequency data item 602. That part of FIG. 6, which lies in the ellipse 603, shows how the access frequency data item 602 is updated. In the example of FIG. 6, the access frequency data item 602 is updated from “F0000000h” to “F0000001h.”

When Blocks 718 to Block 718 are performed, the operating sequence including the write process designated by a write command from the host is terminated. Nonetheless, if the area designated by the write command, which should therefore be accessed, extends over a plurality of logical blocks, Blocks 701 to Block 718 will be repeated, each time for one logical block. The start address of the first logical block and the end address of the last logical block are obtained from the write command. The end address of the first logical block, the start address of the last logical block, and the start address and end address of any other logical block are obtained as addresses that coincide with the block boundaries. Note that Blocks 716 to 718 may be performed in any order possible.

As indicated above, the bit counter 141 counts the bits having the second logical value (“0”) and contained in the data transferred to the nonvolatile memory device Dm (11-m) via the nonvolatile memory I/F 14 to be written to the physical block Pm. On the other hand, the busy timer 142 the access busy period in which to write the data to the physical block Pm provided in the nonvolatile memory device Dm (11-m). If the count value of the bit counter 141 exceeds the threshold value (first threshold value), inevitably influencing the access busy period, the MPU 15 determines that the access busy period measured by the busy timer 142 is valid. In this case, the MPU 15 updates the access busy period data item 502 stored in the busy period area 124 and associated with the nonvolatile memory device Dm, changing the same to a value that represents the access busy period the busy timer 142 has just measured. Therefore, the valid access busy period data held in the busy period area 124 is valid at all times. Hence, valid access busy periods can be managed for all nonvolatile memory devices in the present embodiment.

[First Modification]

A first modification of the embodiment will be described. The first modification is characterized in that the access busy period is measured in preparation not for the write process (more precisely, access to achieve data writing), but for the erase process (more precisely, access to achieve data erasing).

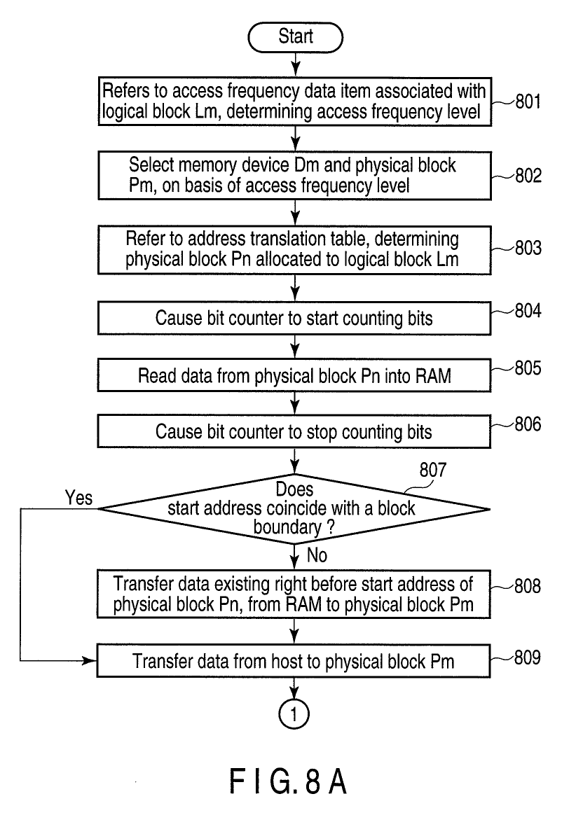

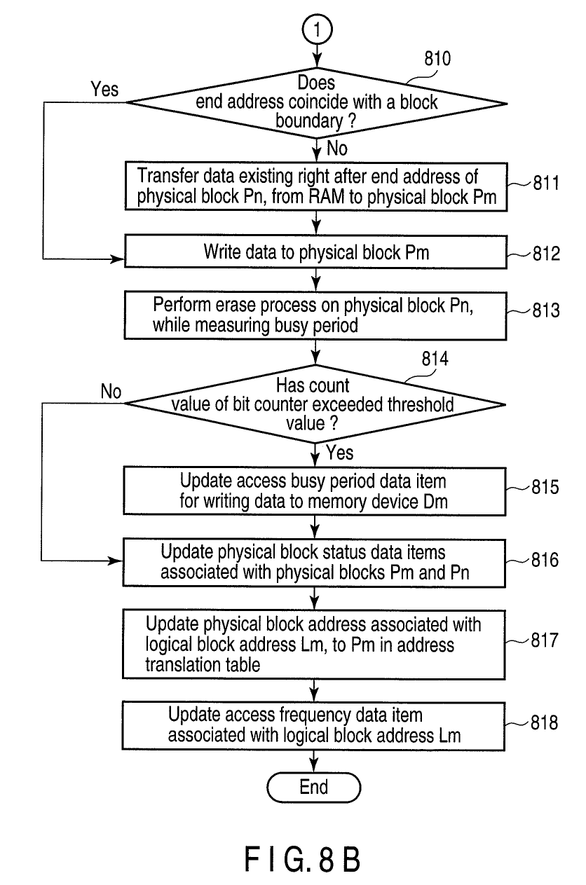

How a storage apparatus 10 according to the first modification operates to process a write command will be explained with reference to the flowchart of FIGS. 8A and 8B, in regard mainly to the technical points that distinguishes the first modification from the first embodiment. First, the MPU 15 performs Blocks 801 to 804 that are equivalent to Blocks 701 to 703 (see FIG. 7A), respectively. The MPU 15 then activates the bit counter 141 provided in the nonvolatile memory I/F 14, causing the bit counter 141 to start counting data bits (Block 804).

Next, the MPU 15 reads data from the physical block Pn through the nonvolatile memory I/F 14. The data thus read is stored in the buffer area of the provided in the RAM 12 (Block 805). On performing Block 805, the MPU 15 causes the bit counter 141 to stop counting bits (Block 806). Thus, in the first modification, the bit counter 141 counts the bits having the second logical value (“0”) and contained in the data (accessed data) read from the physical block Pn in Block 805.

Then, the MPU 15 determines whether the intra-block start address represented by the start address (i.e., start logical address) contained in the write command from the host coincides with a block boundary (Block 807). If the decision made in Block 807 is No, the MPU 15 performs Blocks 808 and 809 that are equivalent to Blocks 707 and 708 shown in FIG. 7B. The decision made in Block 807 may be Yes. In this case, the MPU 15 will perform Block 809, skipping Block 808.

After performing Block 809, the MPU 15 determines whether the intra-block end address represented by the end address (i.e., end logical address) designated by the write command from the host coincides with a block boundary (Block 810). If the decision made in Block 810 is No, the MPU 15 selects the data beginning at a position immediately after the intra-block end address and ending at the end of the block Pn, from all data of the physical block Pn read into the buffer area of the RAM 12, and transfers the data, thus selected, to the physical block Pm provided in the nonvolatile memory device Dm (11-m) through the nonvolatile memory I/F 14 (Block 811). Further, the MPU 15 instructs the nonvolatile memory device Dm (11-m) to write one-block data transferred to the physical block Pm, to the physical block Pm that is provided in the nonvolatile memory device Dm (11-m) (Block 812). If the decision made in Block 810 is Yes, the MPU 15 will perform Block 812, skipping Block 811.

Upon completing the process of writing data to the physical block Pm, the MPU 15 performs, via the nonvolatile memory I/F 14, the process (erase process) of erasing the physical block Pn, setting the same to a not-used state (Block 813). In Block 813, the MPU 15 activates the busy timer 142, which starts measuring an access busy period. The busy timer 142 measures, as access busy period, the period starting from the activation of the busy timer 142 and ending at the time when the erase process of erasing the physical block Pn is completed and the nonvolatile memory device Dm (11-m) is released from the busy state.

When the nonvolatile memory device Dm (11-m) is released from the busy state, the MPU 15 refers to the count value of the bit counter 141, determining whether the count value has exceeded the threshold value (first threshold value) stored in the threshold area 126 (Block 814). Note that the count value of the bit counter 141 represents the number of bits having the second logical value (“0”) and contained in the data (accessed data) read in Block 805 from the physical block Pn into the buffer area of the RAM 12 before the erase process (Block 813) of erasing the physical block Pn is performed.

In order to erase the physical block Pn, erase verification is performed on the cells constituting bits that should be changed in logical value, from the second logical value (“0”) to the first logical value (“1”). Thus, it is determined whether these cells have been set to the voltage level equivalent to the first logical value (“1”). If any cell has not been set to the voltage level equivalent to the first logical value (“1”), an operation of setting the cell to the voltage level equivalent to the first logical value and the erase verification is performed on this cell.

Hence, if the data written to the physical block Pn contains few bits to set to the first logical value (“1”) (i.e., bits having the second logical vale (“0”)), the access busy period in the erase process may become short, not influenced so much by the access speed of the block Pn, even if the access speed is low. If the data written to the physical block Pn contains many bits having the second logical vale (“0”), the access busy period in the erase process is greatly influenced by the access speed of the block Pn, if the access speed is low. In the first embodiment, the access busy period measured by the busy time 142 is therefore utilized as valid only if the count value of the bit counter 141 exceeds the threshold value (first threshold value) (that is, if the decision made in Block 814 is Yes).

That is, if the decision made in Block 814 is Yes, the MPU 15 updates the access busy period data item 502 associated with the device Dm, which is held in the busy period area 124, to the value representing the access busy period the busy timer 142 measures this time. The MPU 15 then performs an updating process (Blocks 816 to 818) that is equivalent to Blocks 716 to 718 shown in FIG. 7B. The decision made in Block 814 may be No. In this case, the MPU 15 will perform Blocks 816 to 818, skipping Block 815.

[Second Modification]

A second modification of the embodiment will be described. The second modification is characterized in that the access busy period data items held in the busy period area 124 are managed in association with physical blocks (more precisely, physical block addresses), respectively. In this respect, the second modification differs the embodiment in which the access busy period data items are managed in association with the nonvolatile memory devices (more precisely, nonvolatile memory device IDs), respectively.

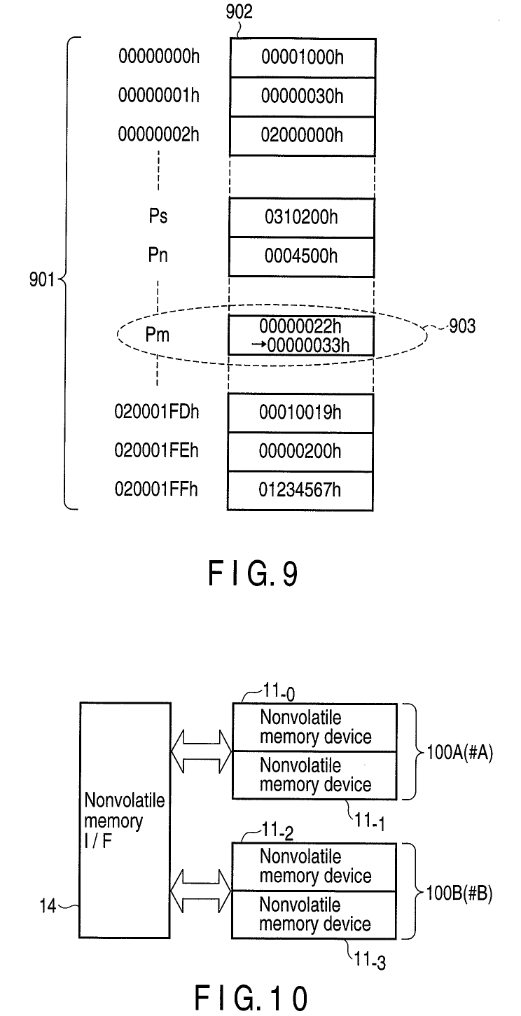

FIG. 9 is a diagram showing an example of access busy period data used in the second modification. As FIG. 9 shows, the access busy period data is managed in the form of a table. Logical block addresses 901 shown in FIG. 9 are equivalent to the indexes of the table. The access busy period data is composed of access busy period data items 902. The access frequency data items 902 are equivalent to the data parts of the table, which are identified with indexes, respectively. In other words, the access busy period data items 902 are associated with the physical block addresses, respectively. Each access busy period data item 902 represents the access busy period in the process of writing data to the physical block designated by the associated physical block address. That part of FIG. 9, which lies in the ellipse 903, will be explained later.

In the second modification that utilizes the access busy data shown in FIG. 9, the MPU 15 may update the access busy period data item 902 associated with the physical block Pm in Block 714 or 815, unlike in the embodiment and the first modification. The second modification can therefore manage access busy periods more minutely, in units of physical block addresses. In the second modification, the MPU 15 selects in Block 702 or 802 a physical block Pm not used yet and having an appropriate busy period, in accordance with the access busy period data (see FIG. 9) stored in the busy period area 124, the physical block status data (see FIG. 4) stored in the status area 123, and the access frequency level (determined in Block 701 or 801). Further, the MPU 15 selects a nonvolatile memory device Dm (11-m) that includes the physical block Pm selected.

Thus, in the second modification, a physical block Pm not used yet and having an access busy period shorter than the threshold value (second threshold value) stored in the threshold area 126 is selected if the access frequency level determined is the above-mentioned first level. If the access frequency level determined is the above-mentioned second level, a physical block Pm not used yet and having an access busy period longer than the second threshold value will be selected.

[Third Modification]

A third modification of the embodiment will be described. Storage apparatuses are known, in which a plurality of physical blocks are associated with one logical block, nonvolatile memory devices are managed in units of groups, and the memory devices of each group undergo simultaneous access or interleaved access, thus accomplishing a high-speed access process. The third modification is characterized in that access busy period data is managed for each group of nonvolatile memory devices in such a storage apparatus.

FIG. 10 is a block diagram showing an exemplary configuration of nonvolatile memory devices used in the third modification. In FIG. 10, the components equivalent to those shown in FIG. 1 are designated by the same reference numbers. As shown in FIG. 10, a nonvolatile memory I/F 14 is connected to nonvolatile memory devices 11-0 to 11-3. The nonvolatile memory devices 11-0 and 11-1 are managed as memory devices of group 100A (#A), while the nonvolatile memory device 11-2 and 11-3 are managed as memory devices of group 100B (#B).

In the nonvolatile memory system of FIG. 10, the nonvolatile memory I/F 14 performs either simultaneous access or interleaved access on the group 100A or 100B. Therefore, the access busy period is measured for each group of nonvolatile memory devices. Although not shown in FIG. 10, two busy timers 142 of the type shown in FIG. 1 are provided for the groups 100A and 100B, respectively.

Since access busy periods are measured for the nonvolatile memory devices of each group, the MPU 15 can perform, decreasing he the access frequency for the group of nonvolatile memory devices, whose access busy period has increased (that is, the access speed has decreased). In order to decrease the access frequency for the group whose access busy period has increased, the data may be migrated from the nonvolatile memory devices of the group to the nonvolatile memory devices of any other group. If the data is so migrated, the storage apparatus 10 can be more reliable.

The nonvolatile memory device 11-m (m=1, 2, . . . , 7) used in the embodiment and modifications (first and second modifications) is a NAND nonvolatile memory. Nevertheless, the NAND nonvolatile memory device 11-m may be replaced by a memory card that incorporates the NAND nonvolatile memory. Alternatively, the NAND nonvolatile memory device 11-m may be a nonvolatile memory other than the NAND nonvolatile memory, or a memory card that incorporates a nonvolatile memory other than the NAND nonvolatile memory.

Moreover, the nonvolatile memory device 11-m may be multi-value memory device. Here, the logical value, which each bit of any physical block provided in a nonvolatile memory device 11-m (multi-value memory) has while the physical block remains in erased state, is defined as “first logical value.” Further, the logical value which each bit of any physical block has while the physical block does not remain in erased state and which is other than the first logical value is defined as “second logical value.” Then, the bit counter 141 may count, as in the embodiment and the first modification, the bits contained having the second logical value (logical value other than the first logical value) and contained in the data transferred to any physical block Pm that should undergo data writing or in the data read from any physical block Pn that should undergo data erasure.

In the embodiment and the modifications thereof, two access frequency levels, i.e., first level and second level, are set. Instead, N access frequency levels (N being an integer greater than 2) may be set, i.e., first level to Nth level. In this case, too, access busy periods are set in the same numbers as the access frequency levels. The higher the access frequency level, the shorter the access busy period the selected nonvolatile memory device (or physical block) will have. Conversely, the lower the access frequency level, the longer the access busy period the selected nonvolatile memory device (or physical block) will have.

In the embodiment and the modifications thereof, the busy timer 142 measures the access busy period every time the write command from the host is executed. Nonetheless, the access busy period may not be measured every time the write command is executed. For example, the access busy period may be measured when the write command is repeatedly executed, a specific number of times, or every time the write command is executed for a specific time after the power switch of the host is turned on.

Furthermore, data may be migrated between the physical blocks irrespective of the execution of the write command from the host, but in accordance with the access busy period of each nonvolatile memory device or with the access busy period of each physical block and the access busy period of each logical block. For example, the first data held in the first physical block of a nonvolatile memory having a long access busy period and allocated to the first logical block having a high access frequency may be replaced by the second data held in the second physical block of a nonvolatile memory having a short access busy period and allocated to the second logical block having a low access frequency. In this case, the first physical block may be reallocated to the second logical block, and second physical block may be reallocated to the first logical block.

The various modules of the storage apparatus described herein can be implemented as software applications, hardware and/or software modules. While the various modules are illustrated separately, they may share some or all of the same underlying logical or code.

While certain embodiments of the inventions have been described, these embodiments have been presented by way of example only, and are not intended to limit the scope of the inventions. Indeed, the novel apparatuses and methods described herein may be embodied in a variety of other forms; furthermore, various omissions, substitutions and changes in the form of the apparatuses and methods described herein may be made without departing from spirit of the inventions. The accompanying claims and their equivalents are intended to cover such forms or modifications as would fall within the scope and spirit of the inventions.

What is claimed is:

1. A storage apparatus accessible from a host, comprising:
a plurality of nonvolatile memory devices divided into a plurality of physical blocks configured to be erased when the bits comprised in the plurality of the physical blocks are set to a first logical value;
a counter configured to count a number of bits indicative of a second logical value in accessed data being written or read while accessing a physical block in a first nonvolatile memory selected among the nonvolatile memory devices;
a timer configured to measure an access busy period during the accessing of a physical block;
a busy period storage module configured to store access busy periods for the nonvolatile memory devices; and
a controller configured to update an access busy period data indicative of the measured access busy period stored in the busy period storage module related to the first nonvolatile memory device, in accordance with a value of the counter.

2. The storage apparatus of claim 1, wherein the controller is configured to update the access busy period data when the count value of the counter exceeds a threshold value.

3. The storage apparatus of claim 1, further comprising an access frequency storage module configured to store access frequency data indicative of access frequencies of logical blocks,
wherein the controller is configured to select a nonvolatile memory device to be accessed, in accordance with the access busy period data and with the access frequency data associated with a logical block designated by the write command when the host gives a write command to the controller, and to select a physical block to be allocated to the logical block designated from the selected nonvolatile memory device.

4. The storage apparatus of claim 3, wherein the controller is configured to update the access busy period data associated with the logical block to which the selected physical block is allocated, in accordance with the accessing of writing data to the selected physical block.

5. The storage apparatus of claim 3, wherein the access busy period of the selected nonvolatile memory device is associated with an access frequency indicated in the access frequency data associated with the logical block designated by the write command.

6. The storage apparatus of claim 5, wherein the controller is configured to determine an access frequency level associated with the logical block designated by the write command, based on the access frequency data associated with the designated logical block, and to select the nonvolatile memory device in accordance with the determined access frequency level.

7. The storage apparatus of claim 6, wherein the controller is configured to select a nonvolatile memory device with a substantially short access busy period when the determined access frequency level is substantially high.

8. The storage apparatus of claim 6, wherein the controller is configured to select a nonvolatile memory device with a substantially long access busy period when the determined access frequency level is substantially low.

9. The storage apparatus of claim 3, wherein the controller is configured to read data as the accessed data from a first physical block allocated to the logical block designated by the write command, to write data to a second physical block which is the selected physical block, and to perform erasing the first physical block after writing the data to the second physical block, in the accessing of a physical block.

10. The storage apparatus of claim 9, wherein:
the counter is configured to count a number of bits indicative of the second logical value in the accessed data being read from the first physical block; and
the timer is configured to measure an access busy period in the erase process as the access busy period in the accessing of a physical block.

11. The storage apparatus of claim 3, wherein:
the access data is designated to be written to the selected physical block;
the counter is configured to count a number of bits indicative of the second logical value in the accessed data while the accessed data is being transferred to the selected nonvolatile memory device; and
the timer is configured to measure an access busy period in the accessing of a physical block for writing the accessed data to the selected physical block.

12. The storage apparatus of claim 1, wherein:
the busy period storage module is configured to store the access busy period data in association with the physical blocks comprised in the nonvolatile memory devices, respectively; and
the controller is configured to update the access busy period data by measuring the access busy period and storing the measured access busy period as the access busy period data in the busy period storage module in association with the physical block in the first nonvolatile memory device.

13. The storage apparatus of claim 12, further comprising an access frequency storage module configured to store access frequency data representing access frequencies at which logical blocks are accessed,
wherein the controller is configured to select a physical block to be allocated to a logical block designated by the write command and a nonvolatile memory device comprising the physical block, in accordance with the access busy period data and with the access frequency data associated with the logical block designated when the host sends a write command to the controller.

14. The storage apparatus of claim 13, wherein the controller is configured to update the access frequency data associated with the logical block to which the selected physical block is allocated, in accordance with the accessing of a physical block for writing data to the selected physical block.

15. The storage apparatus of claim 13, wherein the access busy period of the selected physical block is associated with an access frequency represented by the access frequency data associated with the logical block designated by the write command.

16. The storage apparatus of claim 15, wherein the controller is configured to determine an access frequency level associated with the logical block designated by the write command, based on the access frequency data associated with the logical block, and to select the physical block in accordance with the determined access frequency level.

17. The storage apparatus of claim 13, wherein:
the accessed data is to be written to the selected physical block;
the counter is configured to count a number of bits indicative of the second logical value in the accessed data to be transferred to the nonvolatile memory device; and
the timer is configured to measure an access busy period while writing the accessed data to the selected physical block.

18. The storage apparatus of claim 1, wherein:
the accessed data is to be written to the physical block comprised in the first nonvolatile memory device;
the counter is configured to count a number of bits indicative of the second logical value in the accessed data to be transferred to the first nonvolatile memory device; and
the timer is configured to measure an access busy period while writing the accessed data to the physical block.

19. A method of managing access busy periods of nonvolatile memory devices in a storage apparatus accessible from a host, each of the nonvolatile memory devices divided into a plurality of physical blocks configured to be erased when the bits comprised in the plurality of the physical blocks are set to a first logical value, the method comprising:
counting a number of bits indicative of a second logical value in accessed data being written or read while accessing a physical block in a first nonvolatile memory selected among the nonvolatile memory devices;
measuring an access busy period in the accessing of a physical block; and
updating an access busy period time data stored in a busy period storage module related to the first nonvolatile memory device, in accordance with the number of bits counted.

20. The method of claim 19, further comprising determining whether the number of bits counted exceeds a threshold value,
wherein the access busy period time data is updated when the number of bits counted exceeds the threshold value.
